(19) United States
(12) Patent Application Publication
(10) Pub. No.: US 2026/0208035 A1
(43) Pub. Date: Jul. 23, 2026

(54) Multiplayer System and Procedure

(71) Applicant: A4VR GMBH, Düsseldorf (DE)

(72) Inventors: Michael Albrecht, Düsseldorf (DE); Jan Thiel, Haan (DE); Thomas Hummes, Kaarst (DE)

(21) Appl. No.: 19/138,745

(22) PCT Filed: Dec. 13, 2023
(86) PCT No.: PCT/IB2023/062637

§ 371 Date: Jun. 13, 2025

(30) Foreign Application Priority Data
Dec. 13, 2022 (DE) 10 2022 133 163.6

(51) Int. Cl. A63F 13/212; A63F 13/213; A63F 13/27; A63F 13/327

(52) U.S. Cl. CPC A63F 13/212; A63F 13/213; A63F 13/27; A63F 13/327

(57) ABSTRACT

An immersive real-life real-time multiplayer system for a very large number of players, and a method thereof, including, a plurality of portable trackers (2), arranged to emit a code representing an individual ID; at least one detection unit (3) for direction-dependent detection of a code, the same also arranged to generate data comprising the ID of the associated tracker (2) assigned to this code, as well as position and/or direction and/or rotation of the tracker (2) emitting the code, as well as to provide a data set comprising this data and the ID; a computing unit (4) and at least one display device (5).

### CROSS REFERENCE TO RELATED APPLICATIONS

This is a US national phase entry under 35 U.S.C. §371 of international patent application no. PCT/IB2023/062637, filed under the Patent Cooperation Treaty on 13 Dec. 2023, which claims priority to German patent application no. DE 10 2022 133 163.6, filed in Germany on 13 Dec. 2022, each of which is incorporated by reference in its entirety herein.

### FIELD OF THE INVENTION

The invention relates to computer-assisted multiplayer game systems and more specifically to an immersive real-life multiplayer system for a very large number of players, and a method thereof.

### STATE OF THE ART AND DISADVANTAGES

Computer-assisted games are known in many forms.

On the one hand, games that run purely on a computer system are common, in which the user(s) interact with the game via peripheral devices such as a keyboard and mouse, or via special “controllers” that include additional input options and optional sensors. Optionally, the game also reacts to the player's movements using suitable hardware (e.g. camera, motion sensors) so that no controller is required. However, games are also known in which the player's surroundings are included, for example by using projections on wall or floor surfaces to represent a game environment in which the player then moves (immersive “real-life” gaming).

In the latter case, it is necessary for the computer system to be able to record certain spatial parameters relating to the player, such as their position (X, Y and Z coordinates), direction of movement and their translational and rotational dynamics. For this purpose, radio-based solutions are known from the state of the art, in which, for example, the player's position can be determined by means of a so-called “tracker”, which the player carries with him, e.g. via WLAN or Bluetooth. Systems are also known in which one or more cameras enable optical recognition and tracking of the player. The advantage of this variant is that the player does not need any special hardware.

Preferably, the game is designed as an open system in which a player can enter or leave the game at will without having to log in or out of the system. However, it is only possible to distinguish a player from any other persons in the field of vision of the camera with considerable computing effort. If there are several players (so-called multiplayer games), the effort involved increases even further. Known systems are therefore only suitable for a small number of players, e.g. two to a maximum of 25 players, and/or have insufficient accuracy in terms of position, its change within a time unit and/or the height of the player for a satisfactory user experience with larger numbers of players.

The disadvantages mentioned above increase with the size of the playing field, as the distance between the players and the detection units (cameras) increases, which can only be compensated for by higher quality and/or a higher number of these units. Thus, the use of known systems is typically limited to areas of a few square meters, where the distance to the detection units must also only be a few meters, or large numbers of such units are required, which leads to corresponding costs.

### OBJECT OF THE INVENTION AND SOLUTION

The invention is therefore based on the task of providing an apparatus and a method which avoids the disadvantages of the prior art.

Accordingly, the invention should also allow the integration of a very large number of, for example, 50, 100, 200, 500 or more players of a multiplayer gaming system into an immersive game environment. The system should be open, i.e. it is not necessary for a player to log in or out of the system. The invention should also allow playing on large areas of, for example, 20×20 square meters or more, without impairing the user experience or significantly increasing the costs required for hardware.

### SUMMARY OF THE INVENTION

The apparatus according to the invention and advantageous embodiments thereof are first described below. This is followed by a description of the method according to the invention.

The invention relates to an immersive real-life real-time multiplayer system, suitable for a number of at least 50, preferably 100, 200 or 400 players on an area of at least 100, preferably 500 to 1800 square meters and more. “Real-time” means that no consciously perceptible period of time elapses between an action (e.g. movement) of a player and a “reaction” of the system recognizable by the player; typically the latency is in the range from 1 to 500, preferably from 5 to 200, and particularly preferably from 10 to 100 ms. The system comprises the following components, which are briefly described after they are mentioned:
A plurality of portable trackers.

Each tracker is set up to emit a code that represents an individual ID (identification) of the tracker.

The tracker is intended to be attached to the player's body. It can therefore be attached directly to the body (e.g. directly to the arm or leg, or to clothing, footwear, other accessories, or even to sports equipment used during the game, such as roller skates, ice skates, skateboards, etc., or be integrated into these. It is preferably independent of external energy sources. A user can wear one or more trackers (e.g. to avoid “blind spots” or to improve positioning accuracy). The tracker can also be in one or more parts, i.e. it may have several transmitters that can be positioned differently.

The code representing (encoding) the individual ID enables the tracker to be uniquely identified and thus assigned to the person wearing it. The code is repeatedly and automatically emitted into the environment by the tracker, whereby the signal frequency (the frequency with which the individual bits of the ID encoded by a suitable code are represented) is sufficiently high for a correspondingly accurate resolution in position detection, for example 1,000 or 2,500 Hz. If only the ID is to be transmitted, a signal frequency of 10 Hz may be sufficient. According to one embodiment, the code and its signal frequency are specified when the tracker is programmed, with the highest possible signal frequency being preferred. Alternatively, the code is emitted “on demand” or depending on the situation, as described below. The repetition frequency, i.e. the frequency at which the coded ID is emitted per second, can be defined in two ways. Either an uninterrupted consecutive series of IDs can be sent, so that the number of IDs sent per second depends on the length of the bitwise coded ID. Or the number of IDs emitted per second is specified manually, so that there is a correspondingly long pause between the individual IDs.

### At least one Detection Unit

This is used for the direction-dependent detection of a code. This means that the detection unit can determine the direction from which the code is emitted. Detection takes place in at least two, and preferably three, dimensions. The detection unit is located at a distance from the tracker and the player, for example at the edge of the pitch.

The detection unit is also set up to generate ID data comprising the ID of the associated tracker assigned to this code. This means that the ID of the tracker, which can be generated and transmitted by the tracker in coded form, can be received by the detection unit and decoded again so that it can be added to the data set.

Furthermore, the detection unit is set up to generate movement data comprising the position and/or direction and/or rotation of the tracker emitting the code. In simplified terms, this can therefore be referred to as a “movement” of the tracker; depending on the embodiment, one type or a combination of several types may be desired. Thus, the detection unit serves to generate (and not merely receive) “movement data” of the tracker.

It is clear that the detection unit can only detect and determine the movements of trackers that are also in its field of view.

Finally, it is also set up to provide a “data set” comprising this movement data and the ID data. In other words, the detection unit generates data sets relating to the ID and the position, orientation and/or direction of movement and/or rotation of the tracker, and thus of the person wearing the tracker, and makes this data set available via an interface. This can be wired, but preferably wireless, so that a larger number of detection units can be easily integrated into the system without having to intervene unnecessarily in the playing environment, which can also be outdoors.

### a Computing Unit

The computing unit is intended to generate a list of the IDs of all active trackers, i.e. trackers detected by the at least one detection unit. This means that new players who join the game while it is running, wearing a tracker and identifiable by their individual ID, do not have to be registered with the computing unit, which enables an “open” game environment. However, it is not necessary to announce the IDs of all trackers in advance, which is advantageous.

The computing unit is also set up to receive the data sets provided by the The computing unit is also used to “merge” the movement data, i.e. the positions and/or directions and/or rotations, of all trackers that can be detected in the respective field of view of all detection units for a real or virtual spatial game environment. Accordingly, the data sets originating from the individual detection units, not all of which typically have a simultaneous view of all trackers in the game, are combined (“merged”) on the computing unit to form an overall movement image. This means that one detection unit does not have to cover the entire playing field.

The fields of view of the detection units also typically overlap, as it is almost impossible to achieve a very precise alignment of the fields of view of several detection units. It is therefore possible that the computing unit may receive several data sets for the same tracker; it recognizes this and uses it to form a “final data set” for this tracker, which is then incorporated into the actual game. This only requires a one-off calibration of the detection units in relation to each other before the start of the game (provided they do not move). Furthermore, the computing unit can be set up to interpolate the movement data of successive data sets of a tracker or to recognize and smooth out statistical outliers.

Tests have shown that a relatively simple computing unit, such as a SoC (system-on-chip) environment, is sufficient for all these purposes, i.e. no high-performance and therefore expensive and energy-hungry units are required, which is advantageous. The reason for this lies in particular in the very data-efficient provision of the data sets by the detection units, as will be explained below. Thus, a considerable part of the computing power required for the complete provision of the game environment is shifted away from the computing unit, and the very lean data sets can also be processed faster, which helps to reduce latency times, among other things.
at least one display device for displaying this merged movement data (merged positions and/or directions and/or rotations) of one, several or all trackers present in the game, and/or of representations in said game environment reacting thereto (and thus to the individual player).

Accordingly, the display or visualization device serves to reproduce, in particular visually, the position of the player in the game, and/or to display (also in particular visually) graphics which relate not to the player but to the game environment, in particular in a “dynamic” manner. This means that the game environment changes or (virtual) things are added to or removed from it, depending on how the player moves in the game environment or interacts with it. A simple example is (virtual) directional arrows appearing on a (real) surface as the player approaches, of which the player selects one, whereupon the other directional arrows disappear; the representation therefore takes place “in” the game environment, for example on the playing field, on objects, walls, etc. located there. In addition to the visual representation, the acoustic and haptic representation should also be mentioned; for example, a player's action can be accompanied or acknowledged by a sound, or a (real or virtual) object vibrates or moves when touched by the player.

It should be added that there is usually an additional graphics device (graphics computer) responsible for calculating the graphics, the computing power of which can exceed that of the computing unit according to the invention many times over. However, it is also conceivable that the tasks of the computing unit are also performed by such a graphics unit. Nevertheless, it is envisaged that the calculation of the positions according to the invention and their merging takes place first, and then-for example by transferring the above-mentioned list-this data is visualized by the graphics device.

The invention thus avoids the disadvantages known from the prior art.

Due to the efficient handling of the tracker data, the invention also allows the integration of a very large number of, for example, 50 or more players of a multiplayer game system into an immersive game environment. The system is open, i.e. it is not necessary for a player to log in or out of the system. The invention also allows playing on large areas of 20 x20 square meters or more, for example, without degrading the user experience or greatly increasing the costs required for hardware.

Various embodiments of the invention are described in more detail below.

According to a particularly preferred embodiment, the tracker comprises LEDs for emitting a light code to the remotely located detection unit, i.e. the code is light-based, i.e. it is emitted (using an energy source) by suitable light sources.

The code can preferably be provided by a microcontroller, by means of which both the repetition frequency and (independently of this) the signal frequency, as well as the structure of the signal, can be adapted in order to ensure individual identification of the tracker with simultaneous broad hardware and software support.

According to another embodiment, the code is radio-based, i.e. radio signals encoding the tracker ID are transmitted, which allow conclusions to be drawn about the position etc. of the tracker by means of suitable techniques known to the person skilled in the art, for example with the aid of triangulation. A particular advantage of such radio signals is the possibility of detecting the position of the tracker even when the direct view is obstructed, for example by other players.

A combination of light-based and radio-based code provision is also conceivable. If both techniques are used in parallel, the advantage of the typically higher accuracy of the light-based solution can be utilized and, if necessary, it is possible to fall back on the radio-based solution, which is independent of visual contact, albeit typically somewhat less accurate.

According to one embodiment, the code is transmitted continuously, either at fixed time intervals or in immediate succession.

According to another embodiment, the code is transmitted “on request”, for example only when a detection unit is ready to receive data records. The request can be radio- or light-based (the detection unit transmits a general radio or light signal to all trackers, or an individual radio or light signal that addresses a specific tracker). The latter method in particular allows the amount of data to be further reduced, as the data records do not arrive in parallel and have to be processed accordingly quick, but in series. The request can also be sent more frequently to trackers that are currently in motion than to those that are at rest.

Conversely, the tracker itself can also emit the code depending on the situation, i.e. with a variable time interval between successive transmission events, instead of a continuous repetition with a fixed time sequence. As long as no new code is emitted and received by the detection unit, the latter assumes that the tracker is at rest or on a linear path. In this case, the tracker preferably comprises motion sensors which are linked to the transmitting device (e.g. microcontroller, see above).

The described solution with variable and/or request-based transmission of the code is particularly advantageous for the radio-based solution with localization described above, as such a method has a higher energy requirement compared to the light-based method. This can be significantly reduced by reducing the transmission frequency, which leads to a significant extension of the otherwise limited operating time of the tracker.

According to one embodiment, the tracker comprises a Bluetooth unit by means of which it can be connected to a mobile device of the player. This can then act as a bridge to a local WLAN network.

According to another embodiment, the tracker comprises an integrated power source with charging electronics, so that it can be used without additional cables to an external power source and can be charged directly (for example via a USB-C connection).

According to a further embodiment, the tracker can be set to an energy-saving mode so that the operating time can be extended. The energy-saving mode can be activated, for example, if the tracker does not move for a longer period of time or if the energy source is almost exhausted.

According to another embodiment, the tracker is set up to switch between a low-frequency and a high-frequency transmission (signal frequency) of the ID, for example between a frequency of 10 and 10,000 Hz, between frequencies that differ from each other by a factor of 2, 5, 10, 100 or 1000. In this way, a signal frequency leading to an optimum result can be selected depending on the specific situation (movement standstill, unobstructed view/obscured view).

The advantages of a tracker according to the invention include the avoidance of diffraction or interference effects, especially with light-based tracking; low costs when using an SoC; a low weight, so that no movement restrictions occur; a low latency, provided that an update rate (signal and repetition frequency) is in the microsecond range (1,000 to 10,000 Hz); high energy efficiency due to the use of energy-saving LEDs (with light-based tracking).

According to a preferred embodiment, the detection unit has a camera, which is preferably an event-based camera. This means that the camera only generates and provides data to be forwarded when the recorded image changes. Such cameras are based, for example, on the change in pixel-based brightness values. The corresponding pixel only “reports” if this value changes and otherwise remains “silent”. In this way, a significant reduction in the image data that occurs and therefore needs to be processed can be achieved. An event-based camera can typically process events with a latency of only 0.1 ms or less (e.g. 0.01 ms); this corresponds approximately to a frame rate of 10,000 (or 100,000 or more) FPS of a shutter-based camera.

Preferably, the detection unit is set up for an event rate of at least 10,000 events/second. This means that it can process a corresponding number of incoming signals (e.g. illumination of any LED). Preferably, the event rate is greater than the signal frequency of the tracker by a factor of 2, 10 or 100. In contrast, the term “detection frequency” refers to the number of actual ID detections per second. Preferably, the recognition frequency is the same or particularly preferably significantly greater (e.g. a factor of 2, 10, or 100) than the frame rate (“display frequency”) of the display device, which is typically in the range of 50 to 1000 Hz. Preferably, the latency is between 2 and 20 ms.

According to the invention, the amount of data records that can be provided can be reduced in a technical manner, as explained below.

According to a preferred embodiment, the detection unit has event detection. This means that it can distinguish between a static and a dynamic situation (in particular in relation to the position of an individual tracker). The advantage of this is that it enables event-based provision of the data records; the next data record is only generated and sent if a change in the situation of a tracker curs

The detection unit is particularly preferably set up to reduce the amount of data that can be provided, in particular by extracting the position, direction and/or rotation data (rotations) of a tracker (and particularly preferably all trackers) from the captured image. This means, for example, that the detection unit does not simply record an image of the playing field with the trackers and forwards it, but also “interprets” the same and only forwards the preceding movement data, together with the associated individual ID data, to the computing unit. This significantly reduces the amount of data and at the same time distributes a considerable part of the computing load from the computing unit to a large number of detection units, each of which in turn only has to provide a manageable amount of computing power that can be provided with inexpensive hardware.

If the number of players is increased above a certain value that exceeds the processing capabilities of the existing detection units, additional detection units are simply added to the system. This increases the computing load of the computing unit only slightly, as processing the additional data volume, which has already been reduced in advance, requires only a small amount of additional computing power.

According to a particularly preferred embodiment, the detection unit is an e vent-based camera that can be operated with an event rate that exceeds a signal frequency of the tracker signal by a factor of 2, preferably by a factor of 10, and particularly preferably by a factor of 100, so that the detection unit can automatically recognize the clocking of the tracker signal (resulting from or corresponding to the signal frequency). In this way, the detection unit can automatically synchronize itself to the signal from the tracker, without the need for external synchronization between the detection unit and the tracker, which is otherwise typically required. This reduces the effort and complexity required to set up the system, reduces the cost of the tracker and simplifies the operation of the system.

According to one embodiment, the system comprises at least one input unit for at least one player. The input unit is used to expand the player's interaction options with the game. For example, it can be a joystick or a so-called “controller” (control device, “gamepad”), which is typically made available to the player. However, a cell phone can also be considered, possibly supplemented by software; for example, commands can be easily sent to the detection or computing unit or information can be exchanged with it. So-called “smartwatches” can also be considered. The use of body sensors, which in particular detect the player's movement and/or speed, is also possible. Such sensors can also be provided by means of the aforementioned cell phone or smartwatch, in which they are typically installed anyway.

According to a further embodiment, the system comprises gesture recognition integrated in the detection unit and/or based in the computing unit. In other words, either the detection unit is set up in such a way that it can recognize and interpret the gestures of a player wearing the tracker; then the data set to be sent by it is supplemented by the corresponding information. Or images or videos of the player are recorded by the detection unit and forwarded to the computing unit with the data set; the computing unit is then programmed to recognize the gestures and draw the associated conclusions relating to the game and “react” accordingly.

According to one embodiment, the detection units look at the playing field essentially vertically, i.e. at an angle of 90°±5°. . . 10°. They can, for example, be attached to a rig suspended several meters above the playing field.

According to a further embodiment, at least some of the detection units are directed onto the playing field at a non-perpendicular angle, i.e. at an angle of 45°±40°, preferably 45°±30°, and particularly preferably 45°±15°. This means that the detection units arranged above the playing field are tilted away from the vertical; preferably in the direction of the center of the playing field. The detection units can also be arranged at least partially to the side of the playing field and look towards the center of the playing field according to their tilted orientation.

The advantage of such detection units positioned at an angle to the playing field is that they allow perspective processing of the tracker information. This makes it possible to detect more complex movement patterns and better recognize player falls, collisions between several players and virtual inputs through movements and gestures. In combination with the use of VR/AR/MR/XR goggles, players can be integrated into the virtual representation with movement and full body.

It is possible for the system to include both event-based and non-event-based detection units. In particular, the detection units operated in an angled orientation can also be of the non-event-based type. A further advantage of a combination of event-based and non-event-based detection units is the ability of the latter to provide high-precision images even at very high speeds. Subsequent interpolation of the results of both types can therefore lead to particularly precise results.

According to one embodiment, the system is set up to combine a real playing field with a virtual playing field. This means that it comprises means that “overlay” the real playing field so that virtual elements can be added to it. In particular, the display device mentioned above and described in more detail below is used for this purpose.

According to one embodiment, said display device is in the form of a single or multi-part screen. The screen or screens can be used to display an exclusively virtual playing field or be integrated into a real playing field.

The display device can also be in the form of one or more projectors; the two above variants are also conceivable here.

The display device can also be provided in the form of augmented reality or virtual reality (AR/VR) glasses provided for each player; here too, the playing field can be purely virtual or a combination of virtual and real playing field.

According to a further embodiment, the display device is provided in the form of wall and/or floor tiles; these can be suitably integrated into a real playing field.

Finally, the display device can be provided in the form of a mobile device (cell phone), preferably a smartphone or tablet. The player uses this to move through the game environment. It is also possible to superimpose an AR image on the game environment, similar to AR glasses.

According to further embodiments, the display device is set up to generate acoustic, tactile or olfactory effects; reference is made to the explanations above.

Of course, combinations of the aforementioned embodiments of the display device(s) are also conceivable.

According to one embodiment, the detection unit(s) is/are stationary, i.e. permanently installed at a specific location. Such an embodiment is particularly suitable for playing fields that are enclosed spaces and/or are permanently used as a playing field.

According to another embodiment, the detection units are mobile and have wheels, run on rails or are attached to a drone, for example. The latter embodiment in particular has the advantage of the greatest possible flexibility. It is clear that in the case of mobility, each detection unit must know its own position and possibly movement in space and incorporate it into the respective data set so that it contains the correct information of the tracker relative to the (stationary) playing field. Alternatively or additionally, the detection unit position can also be communicated to the computing unit when the game is initialized.

According to a particularly preferred embodiment, the system comprises at 1 east 100 trackers, set up to transmit the respective codes at preferably regular intervals, with an integrated energy source with charging electronics.

It further comprises a plurality of detection units in the form of event-based cameras, whereby these are set up to achieve an accuracy of 10 cm, and can also achieve a detection frequency target which corresponds to at least twice the display frequency of a display device. It is clear that the detection units also have the option, described in detail above, of generating data sets from the received codes and the detected movements (positions, directions, rotations) of the individual trackers in order to ensure, among other things, the downstream determination of the movement data of all players in real time.

Furthermore, the system comprises a computing unit for merging the movement data of the trackers and thus of the players.

Finally, the preferred system comprises a plurality of display devices, each set up to achieve a resolution which corresponds at least to the accuracy of the aforementioned detection devices.

To avoid repetition, reference is made to the above explanations. A system equipped in this way fulfills the above-described task of integrating a very large number of players in an open, immersive gaming environment.

The invention also relates to a method for operating an immersive real-life real-time multiplayer system, suitable for a number of at least 50 players in an area of at least 100 square meters for continuous real-time interaction of all players with a game, wherein the system comprises a plurality of portable trackers, at least one detection unit for directional detection of a wirelessly transmitted code, a computing unit and a display device. For an explanation of these components, reference is made to the above description thereof.

The method according to the invention comprises the following steps:
transmitting a code representing an individual ID from a tracker;
detecting the code by the detection unit arranged at a distance from the tracker and player;
determining the ID data and the movement data (position and/or direction and/or rotation) of the tracker by means of the detection unit, combining and providing this data in the form of a data set;
receiving this data set by the computing unit and fusing the positions and/or directions and/or rotations of all trackers detectable in the respective field of view of all detection units for a real or virtual spatial game environment;
displaying these merged positions and/or directions and/or rotations, and/or graphics reacting thereto in said game environment by means of the display device.

Preferably, a plurality of trackers (e.g. 50 or more), and a plurality of detection units (e.g. 2 to 30 or more) are present. The data records are transmitted by the respective detection units at a rate acceptable for the game; this can be in the range of a few seconds, but also significantly less, for example in the range of 50 milliseconds and less (i.e. 20 times per second and more frequently). It is also possible to adapt the data rate to the actual change in position or direction of movement of the tracker. To avoid repetition, reference is also made to the above explanations of the system according to the invention, which apply analogously to the method.

Preferably, when a further tracker enters the field of view of a detection unit (and thus when a player “enters” the playing field), its position, direction and/or rotation is also determined and provided by the detection unit and recognized by the computing unit as a further player and integrated into the playing environment. Similarly, when a tracker leaves the fields of view of all detection units (and thus the playing field), the data of this tracker is no longer taken into account and the player assigned to it is removed from the playing environment.

It is not necessary for a new tracker to be registered with the computing unit or for a tracker to be removed to be deregistered from it. This is possible without having to communicate the IDs of the trackers to the computing unit once in advance (e.g. before the game starts). In addition, manual synchronization (i.e. initial “notification”) with the detection units and/or the computing unit is also not necessary.

According to one embodiment, the player interacts with the computing unit by means of an input unit and/or gesture recognition, as already described above. However, it should be noted that such interaction possibilities are optional, since the basic interaction in the normal case is solely the presence and possibly movement of the player in the game, detected by the detection unit(s).

The data reduction described above is particularly preferred. This means that only when the situation of the tracker changes its data set is sent, and/or that only the data relating to the position, direction and/or rotation of a tracker is provided by the detection unit, so that the amount of data provided is minimal and a large number of trackers can be integrated simultaneously into the game environment by the computing unit in real time. Together with the ID data of the associated tracker, a small data set is formed, which is then transmitted wirelessly or by cable to the computing

According to a preferred embodiment, the detection unit designed as an event-based camera is operated at an event rate which exceeds a signal frequency of the signal of the tracker by at least a factor of 2, so that the detection unit automatically recognizes a clocking of the signal of the tracker, so that the detection unit automatically synchronizes to the signal of the tracker without the need for external synchronization between the detection unit and the tracker. Reference is also made to the explanations above.

Depending on the design of the game or the purpose of use, the acceptance range of the transmission rate of data sets provided by the detection unit varies. Therefore, according to one embodiment, in order to avoid recognizable position deviations from the actual and the calculated position of a tracker, “intermediate positions” between two actually detected positions are determined by means of interpolation, or expected positions are determined by means of extrapolation, in particular by the computing unit. This means that through the targeted use of interpolation and extrapolation methods in environments where the update frequency is actually too low, a “smooth” image can still be generated. This means that transmission rates above the actual provision frequency of the data sets can also be “simulated” by the detector unit (for example in conjunction with its image frequency) without causing visual restrictions (e.g. visible position deviations) in the game. The interpolation can of course also affect the movement and/or rotation of the tracker.

According to one embodiment, the latency between the actual position of the t racker and its position detected in the game (possibly determined from merged data sets) is less than 10 milliseconds. This means that in most situations, user will not notice an offset between the actual position and the calculated position in the game.

It is also possible that the latency is adjusted depending on the speed and/or speed change of the tracker, i.e. that latencies of less than 10 ms, for example 8, 5 or 2 ms, are set in situations with a high rate of change, whereas latencies of 50, 100 or 500 ms can be tolerated for slow movements or even standstill. By adjusting the latency depending on the situation, resources can be used more efficiently and, for example, the operating time of the tracker can be extended.

### BRIEF DESCRIPTION OF THE DRAWINGS

In the following, the invention is explained by way of example with the aid of figures.

FIG. 1 shows an embodiment of the system according to the invention using the example of an ice rink;

FIG. 2 schematically shows a person participating in the game with a tracker;

FIG. 3 shows a schematic of an embodiment of a tracker;

FIG. 4 shows a schematic of another embodiment of a tracker;

FIG. 5 shows the tracker according to FIG. 4 with a view of the interior;

FIG. 6 shows a flow chart illustrating the method according to the invention,

FIG. 7 shows a diagram explaining the automatic synchronization.

### DETAILED DESCRIPTION OF EMBODIMENTS

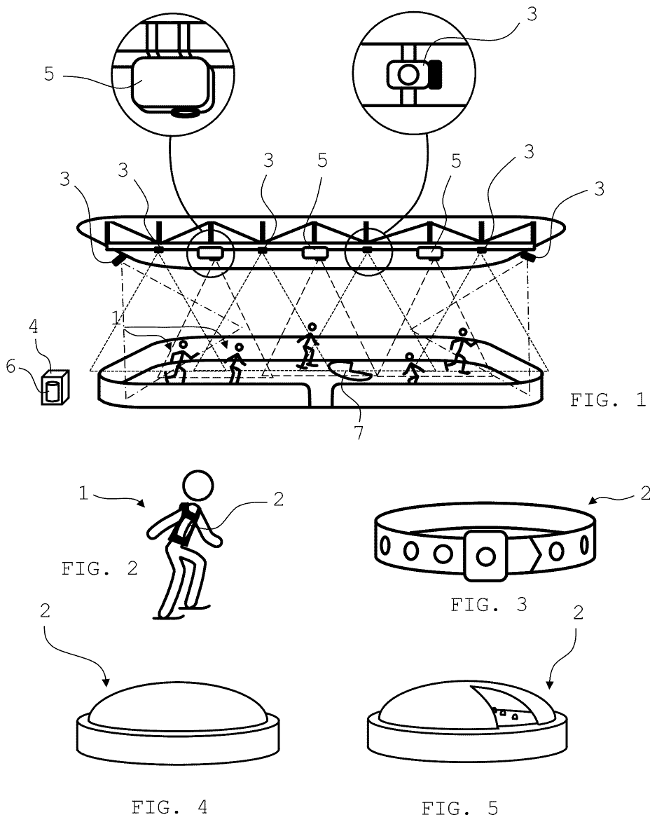

FIG. 1 shows an embodiment of the system according to the invention using the example of an appropriately equipped ice rink.

Each of the players 1 (not all marked with reference signs) wears a tracker 2 (not shown). Several vertically downwardly directed detection units 3 are arranged on the hall ceiling. These have the entire playing field in view, schematically indicated by the dotted outlined areas (depth coverage not shown). The detection units 3 arranged at the two ends (right and left in the image) are aligned at a non-perpendicular angle to the playing field; the areas covered are indicated by the dotted lines. This makes it possible to detect more complex movement patterns. Also arranged on the hall ceiling are several display devices 5, which can be used to project images onto the “playing field”, in this case the floor the ice rink; the beam path is indicated by a dashed area (depth coverage not shown).

A computing unit 4 is shown to the side of the playing field. This receives (via radio or cable-based, connection not shown) the data sets provided by the detection units 3, which comprise the ID data of the individual trackers 2 of the players 1 in the respective tracker field of view, as well as the movements (positions, directions, rotations) of the trackers 2, which are determined by the detection units 3. Using the data sets, the computing unit 4 can determine the movements of all players 1, possibly by merging the data sets (see above). The computing unit in turn supplies data for graphic display to the display devices 5 by radio or cable (transmission path not shown). These then project graphics onto the playing field, for example, which can be related to the individual position, direction or game situation of the individual players 1. A virtual object 7 in the form of a playing figure is projected as an example. Since the computing unit has access to a list 6 of all IDs of the trackers 2, it is not necessary to register a new player 1 entering the playing field with the computing unit 4, which results in an open game environment.

FIG. 2 schematically shows a person participating in the game (player 1) with tracker 2. In this case, the tracker 2 is attached to the front of a vest worn by player 1; in fact, a position on the back or shoulder may be more advantageous. It is also possible to have several trackers 2, or to divide the tracker 2 into several sub-units, one of which is responsible for generating the code and several others for transmitting the code at different locations.

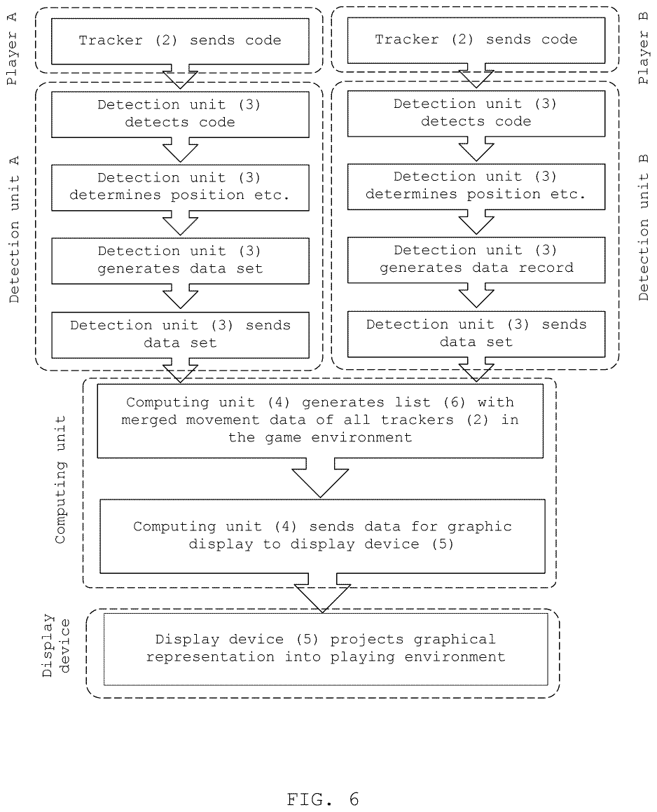

The tracker can also be in the form of a belt, as shown in FIG. 3, with several LEDs arranged around its circumference. In this way, the probability that the position of player 1 is accidentally covered by other players 1 or objects and thus cannot be detected is very low. The belt can of course also carry the power supply and any other components that may be required. The light signals emitted by the LEDs are then picked up by the remote detection units (not shown).

As Shown in FIG. 4 and FIG. 5, the Tracker 2 Shown in FIG. 2 can comprise a base with a cap (transparent for the selected wavelength). FIG. 5 shows that a plurality of LEDs intended for emitting the code are arranged under the cap.

FIG. 6 shows a flow chart illustrating the method according to the invention. The left-hand column lists the steps relating to a player A, while the right-hand column lists the steps relating to a player B. Each of the players wears a tracker 2, which emits an individual code. The code is picked up by a detection unit 3 (A or B) ; however, it would also be conceivable for both codes to be picked up by the same detection unit 3 if the spatial situation allows this. The detection units 3 determine the ID from the code and calculate the position, movement and rotation of the respective tracker 2 and thus of the player A or B. From this data (ID data and movement data), the detection units 3 each generate a data set, which they then send to the computing unit 4. This generates a list 6 containing the IDs of all active trackers 2 currently in the game and supplements this list with the merged movement data of the trackers 2. This allows all movements of all trackers 2 (and thus players 1) on the playing field to be determined, whereby any trackers 2 that have been detected multiple times are combined and all data records of all trackers 2 finally are incorporated (merged) for further calculation in the game. Depending on requirements, the computing unit 4 can now calculate a graphical representation which relates to the movements of the players 1 on the playing field or, for example, virtual objects 7 with which the players 1 can interact. Finally, the display unit 5 can bring the representation onto the playing field in a suitable manner, for example by means of projection. There, the players 1 in turn interact with the display and, if necessary, change their position, which in turn is passed on to the computing unit 4 by means of the tracker 2 and the detection devices 3, so that continuous real-time interaction of all players 1 with the game is possible.

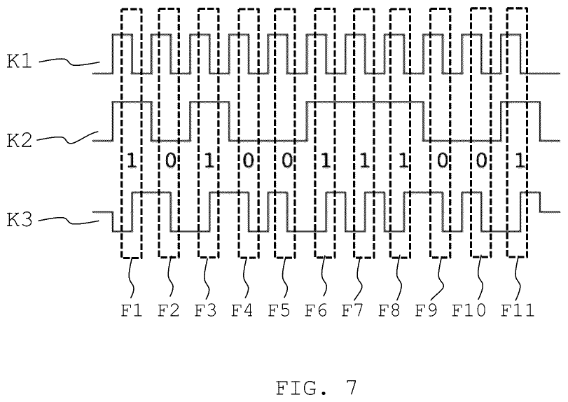

FIG. 7 shows a diagram to explain the automatic synchronization.

The top curve K1 symbolizes the clock frequency by means of which an electronic component, which converts the ID into binary light signals, is controlled.

The curve K2 below symbolizes a bit sequence that represents the ID in binary form. The bits are generated with the signal frequency (“period”) already explained above, which is just half the clock frequency. If this curve K2 were now to be used directly to control an LED of the tracker, for example, a detection device that picks up the binary light signal would have to be set up to detect not only the edges but also the lengths of the sections with “1” and “0”, which is complex due to the demanding time synchronicity required for this. In particular, the device would also have to receive the signals with a high resolution at all times in order to ensure that none of the bits of curve K2 are overlooked.

It is therefore advantageous to use a suitable code, such as the Manchester code (curve K3) in particular, which encodes the binary signal of curve K2. This code also follows the fundamental frequency. The mode of operation of the Manchester code, which receives the clock signal during coding, is known to the person skilled in the art and therefore requires no detailed explanation. As can be seen, a rising edge represents a “1”, while a falling edge represents a “0”. There is at least one edge per bit from which the clock signal can be derived. The Manchester code is therefore self-synchronizing. Since no second signal needs to be transmitted for synchronization, communication between tracker 2 and detection unit 3 is simplified and the complexity of tracker 2 can be reduced. In addition, the use of communication that is sufficient for the present purpose, but not unnecessarily complex, results in a lower load on the detection unit 3 with computing operations, which leads to a maximization of the number of trackers 2 that can be covered by a single detection unit 3, and thus an improvement in real-time capability.

The vertical dashed “windows” F1 to F9 represent the time periods in which a detection unit “sees” the coded signal. If a rising edge occurs in a window of curve K3 (F1, F3, F6-F8, F11), a “1” is also detected, and vice versa (F2, F4, F5, F9, F10). However, this detection only works reliably if the detection unit and tracker are synchronized with each other. In the present case, synchronization is achieved simply by the detection unit initially starting detection with an event rate that is clearly too high. The incoming signals are stored and analyzed in such a way that the above-mentioned “period” (signal frequency) is detected. This process typically takes less than a second. Once the signal frequency has been determined, the event rate can be reduced accordingly by adjusting it to the signal frequency. Only then are the “windows”, which were previously clearly too short and too close together, at the correct distance from each other, which is characterized by the fact that each window lies just above a rising or falling edge of the coded signal (curve K3). In this way, the otherwise usual need for external synchronization, for example by manually connecting the trackers to the detection units by means of a cable before the start of the game, or even at regular intervals during the game if the fundamental frequencies differ slightly from each other, for example due to temperature influences, is eliminated.

### REFERENCE SYMBOL LISTING

1 player
2 tracker
3 detection unit
4 computing unit
5 display unit
6 list
7 virtual object
K1-K3 curve
F1-F11 window

1. An immersive real-life real-time multiplayer system, suitable for at least 50 players (1) in an area of at least 100 square meters for continuous real-time interaction of all players (1) with a game, the system comprising:
a plurality of portable trackers (2) configured to transmit a code representing an individual ID;
at least one detection unit (3) spaced apart from the player (1) for directional detection of the code, also designed to generate ID data comprising the ID of the associated tracker (2) assigned to this code, as well as motion data comprising the position and/or direction and/or rotation of the tracker (2) transmitting the code, and for providing a data set comprising this movement data and the ID data;
a computing unit (4) provided for generating a list (6) of the IDs of all trackers (2) detected by the detection unit (3), designed for receiving the data sets, and for merging the movement data of all trackers (2) detectable in the respective field of view of all detection units (3) for a real or virtual spatial game environment; and
at least one display device (5) for displaying this merged movement data and/or representations thereof in the said game environment.

2. The system according to claim 1, wherein the tracker (2) comprises LEDs for transmitting a light code to the detection unit (3).

3. The system according to claim 1, wherein the tracker (2):
transmits the code at regular intervals, or
transmits the code at irregular intervals as required by the situation, or
transmits the code upon request from the detection unit (3).

4. The system according to claim 1, wherein the tracker (2);
has a Bluetooth unit by means of which it can be connected to a mobile device of the player (1);
comprises an integrated energy source with charging electronics;
can be switched to an energy-saving mode; and
is designed to switch between a low and a high signal frequency.

5. The system according to claim 1, wherein the detection unit (3):
comprises a camera which is an event-based camera; and/or
has an event rate which is at least a factor of 2 greater than the signal frequency of the tracker; and/or
with which a recognition frequency can be provided which corresponds to at least one display frequency of the display device (5).

6. The system according to claim 1, wherein the detection unit (3) is designed to reduce the amount of data sets that can be provided by means of:
event detection and/or
extraction of the positions and/or directions and/or rotations of all trackers (2) that can be detected in the respective field of view of all detection units.

7. The system according to claim 1, wherein the detection unit (3) is an event-based camera which can be operated at an event rate which exceeds a signal frequency of the signal of the tracker (2) by at least a factor of 2, so that the detection unit (3) can automatically detect a clocking of the signal of the tracker (2) so that the detection unit (3) can be synchronized automatically with the signal of the tracker without the need for external synchronization between the detection unit (3) and the tracker (2).

8. The system according to claim 1, further comprising:
at least one input unit for at least one player (1), and/or
a gesture recognition integrated in the detection unit (3) and/or based in the computing unit (4)
for interaction of the player (1) with the computing unit (4).

9. The system according to claim 1, wherein at least some of the detection units (3) are directed at the playing field at a non-perpendicular angle of 45°±15°, and/or the system comprises both event-based and non-event-based detection units (3).

10. The system according to claim 1, designed to combine a real playing field with a virtual playing field.

11. The system according to claim 1, wherein the display device (5) is in the form of
a single or multi-part screen,
one or more projectors,
augmented reality or virtual reality glasses provided for each player (1),
wall and/or floor tiles, and/or
a mobile terminal device
and/or is designed to generate acoustic, tactile, or olfactory effects, or is a combination thereof.

12. The system according to claim 1, wherein the detection unit (3) is stationary or mobile.

13. An immersive real-life real-time multiplayer system for continuous real-time interaction of all players (1) with a game, comprising:
at least 100 trackers (2) as defined in claim 2, designed to transmit the respective codes as defined in claim 3, with an integrated energy source with charging electronics as defined in claim 4;
a plurality of detection units (3) arranged at a distance from the player (1) in the form of event-based cameras as defined in claim 5, designed to achieve a recognition frequency which is at least twice the display frequency of a display device (5) and to achieve an accuracy of 10 cm;
a computing unit (4) for merging the movement data of the trackers (2); and
a plurality of display devices (5), each designed to achieve a resolution which corresponds at least to the accuracy of the detection devices (3).

14. A method for operating an immersive real-life real-time multiplayer system, suitable for a number of at least 50 players (1) on an area of at least square meters for continuous real-time interaction of all players (1) with a game, the system comprising a plurality of portable trackers (2), at least one detection unit (3) spaced apart from the player (1) for directionally detecting a wirelessly transmitted code, a computing unit (4) and a display device (5), comprising the following steps:
transmitting a code representing an individual ID from a tracker (2);
detecting the code by the detection unit (3);
determining the ID data and the movement data comprising the position and/or the direction and/or the rotation of the tracker (2) by means of the detection unit (3), combining and providing this data in the form of a data set;
receiving this data set by the computing unit (4) and calculating the movement data of all trackers (2) detectable in the respective field of view of all detection units (3) for a real or virtual spatial game environment; and
displaying this movement data and/or graphics reacting thereto in the said game environment by means of the display device (5).

15. The method according to claim 14, wherein:
when a further tracker (2) enters the field of view of a detection unit (3), its position, direction and/or rotation is also determined and provided by the detection unit (3) and recognized by the computing unit (4) as a further player (1) and integrated into the game environment, and
when a tracker (2) leaves the fields of view of all detection units (3), the data of this tracker (2) is no longer taken into account, and the player (1) assigned to it is removed from the game environment,
without a newly added tracker (2) having to be registered with the computing unit (4) or a tracker (2) to be removed having to be deregistered from it.

16. The method according to claim 14, wherein the player (1) interacts with the computing unit (4) by means of an input unit and/or gesture recognition.

17. The method according to claim 14, wherein the data set of the tracker (2) is only sent when the situation of the tracker (2) changes, and/or wherein only the movement data relating to the position, direction, and/or rotation of a tracker (2) is provided by the detection unit (3), so that the amount of data provided is minimal and a large number of trackers (2) can be integrated simultaneously by the computing unit (4) into the game environment in real time.

18. The method according to claim 14, wherein the detection unit (3) implemented as an event-based camera is operated at an event rate that exceeds a signal frequency of the signal of the tracker (2) by at least a factor of 2, so that the detection unit (3) automatically detects a clocking of the signal of the tracker (2), so that the detection unit (3) automatically synchronizes to the signal of the tracker (2) without the need for external synchronization between the detection unit (3) and the tracker (2).

19. The method according to claim 14, wherein, in order to avoid detectable position deviations from the actual and calculated position of a tracker (2), intermediate positions between two actually detected positions are determined by means of interpolation or expected positions by means of extrapolation.

20. The method according to claim 14, wherein the latency between the actual position of the tracker (2) and its position detected in the game and reproduced on the display device (5) is less than 10 milliseconds and/or is adjusted depending on the speed and/or speed change of the tracker (2).
